(19) United States
(12) Patent Application Publication
(10) Pub. No.: US 2026/0039956 A1
(43) Pub. Date: Feb. 5, 2026

(54) USING A SECONDARY CAMERA FOR GENERATING TRUE OPTICAL BLUR IN REAL TIME VIDEO

(71) Applicant: Cisco Technology, Inc., San Jose, CA (US)

(72) Inventors: Erik Hellerud, Oslo (NO); Øystein Damhaug, Jessheim (NO)

(21) Appl. No.: 18/794,242

(22) Filed: Aug. 5, 2024

(51) Int. Cl. H04N 23/61; H04N 23/67; H04N 23/80

(52) U.S. Cl. CPC H04N 23/676; H04N 23/61; H04N 23/67; H04N 23/675; H04N 23/80

(57) ABSTRACT

A method and system are provided for optically blurring a background against a foreground in a video captured using a main camera and a secondary camera in a video endpoint device. A first video stream is acquired using a main camera of a video endpoint device and a foreground object is detected in the first video stream. A foreground mask video stream is generated based on the foreground object detected in the first video stream. A second video stream is acquired from a secondary camera of the video endpoint device that is adjusted to be intentionally out of focus. The foreground mask video stream and the second video stream are combined to generate an output video stream that includes the foreground object against a background that is optically blurred by the secondary camera.

### TECHNICAL FIELD

The present disclosure relates to video processing, and more specifically, to obtaining a true optical blur on a background with respect to a foreground object of a video on a video endpoint device.

### BACKGROUND

Current video processing applications enable a user to blur a background with respect to a foreground object through digital image processing. Generally, background blur algorithms on video devices use image processing tools such as artificial intelligence (AI) to find a foreground mask and the background is blurred using filters, such as a simple box filter. Such image processing tools run fast and are suitable for high frame rates but fail to generate a realistic and pleasant looking blur. Improving the visual quality of the background blur by means of additional image processing is not a viable solution due to the desired output video frame rate, video resolution and available processing power.

### BRIEF DESCRIPTION OF THE DRAWINGS

FIG. 1 is a block diagram depicting a system for optically blurring a background in a video, according to an example embodiment.

FIG. 2 is a block diagram depicting an operational flow of a video endpoint device incorporating the system of FIG. 1 for optically blurring a video, according to an example embodiment.

FIG. 3 is a schematic side view depicting a foreground object and a background object captured by a main camera and a secondary camera, according to an example embodiment.

FIG. 4A depicts an image of a first view captured by a main camera, according to an example embodiment.

FIG. 4B depicts an optically blurred image of the first view captured by a secondary camera, according to an example embodiment.

FIG. 4C depicts a final image of the first view generated by combining a foreground object mask and the optically blurred image of background, according to an example embodiment.

FIG. 5A depicts an image of a second view captured by a main camera, according to an example embodiment.

FIG. 5B depicts an optically blurred image of the second view captured by a secondary camera, according to an example embodiment.

FIG. 5C depicts a final image of the second view generated by combining a foreground object mask and the continuously updated optically blurred background image, according to an example embodiment.

FIG. 6 is a flow chart depicting a method for optically blurring a background in a video, according to an example embodiment.

FIG. 7 is a flow chart depicting a method for generating an artificial image of the background from the optically blurred video captured by the secondary camera, according to an example embodiment.

FIG. 8 depicts an artificial image of the background, according to an example embodiment.

### DETAILED DESCRIPTION

### Overview

According to one embodiment, methods are provided for generating true optical blur in video. A first video stream is acquired using a first camera of a video device and a foreground object is detected in the first video stream. A foreground mask video stream is generated based on the foreground object detected in the first video stream. A second video stream is acquired from a second camera of the video device that is adjusted to be intentionally out of focus. The foreground mask video stream and the second video stream are combined to generate an output video stream that includes the foreground object against a background that is optically blurred by the second camera.

### Example Embodiments

Embodiments are presented herein for video processing, and more specifically, to arrangements for obtaining a true optical blur on a background with respect to a foreground object of a video on a video endpoint device.

A video conference system enables audio and video communication between video endpoint devices. During real-time audio and video communication, the user may choose to blur the background and ensure focus is on the user's face. A background blur is a typical feature in video endpoint devices, such as, a mobile device.

However, conventional techniques adapted for generating background blur include algorithms using digital processing on real-time video or using artificial intelligence (AI)-based off-line processing. Digital processing may be applicable to real-time video, but the resulting background blur is often low quality. Conventional AI-based processing is known to generate high quality background blur through generation of a foreground mask. However, in order to process the video to generate high quality video, off-line processing may be required, rendering it unsuitable for real-time video processing. Also, AI processing tools run fast and are suitable for high frame rates but fail to generate a realistic and pleasant looking blur, resulting in the need for additional AI processing. Moreover, there is a concern for video processing related to power requirements. A video endpoint device performing real-time processing may not have the power budget that is required for generation of high quality video through real-time AI-based processing. Video endpoint devices generally include a single camera with a fixed focus.

Accordingly, embodiments are presented herein that enable video processing, and more specifically, that provide for obtaining a true optical blur on a background with respect to a foreground object in a video stream captured by a video endpoint device. The video endpoint device includes a main camera and a secondary camera to be used at the same time, and the secondary camera is intentionally defocused. The main camera is primarily configured to focus on the foreground object. Image processing operations are implemented to obtain a margin and/or position of the foreground object. The camera settings of the main camera and the secondary camera are adjusted based on the obtained position of the foreground object. The video endpoint device is arranged to combine foreground information obtained from the image processing with the intentionally defocused video data captured (of the background) from the secondary camera to generate an output video with a foreground against an optically blurred background.

It should be noted that references throughout this specification to features, advantages, or similar language herein do not imply that all of the features and advantages that may be realized with the embodiments disclosed herein should be, or are in, any single embodiment. Rather, language referring to the features and advantages is understood to mean that a specific feature, advantage, or characteristic described in connection with an embodiment is included in at least one embodiment. Thus, discussion of the features, advantages, and similar language, throughout this specification may, but does not necessarily, refer to the same embodiment.

Furthermore, the described features, advantages, and characteristics may be combined in any suitable manner in one or more embodiments. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages will become more fully apparent from the following drawings, description, and appended claims, or may be learned by the practice of embodiments as set forth hereinafter.

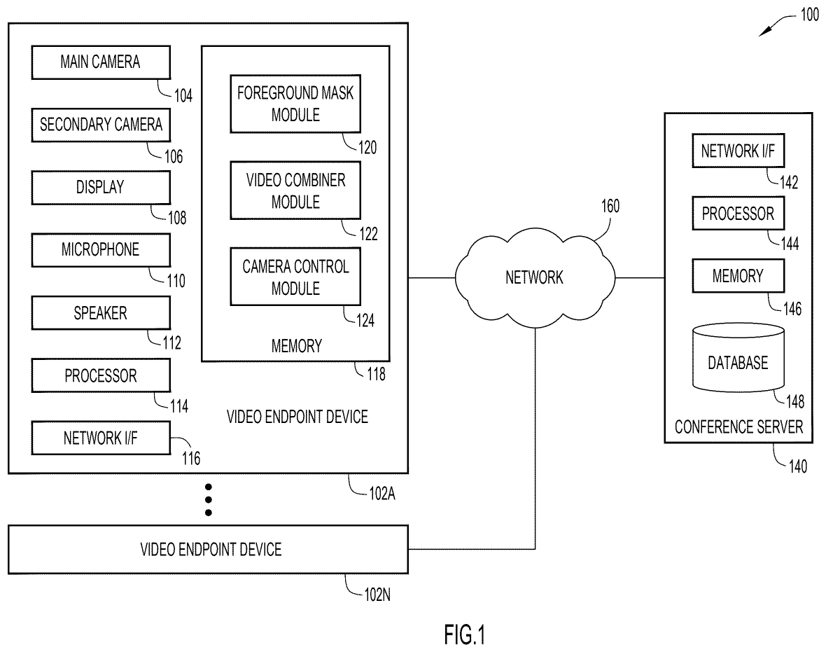

Embodiments will now be described in detail with reference to the Figures. FIG. 1 is a block diagram depicting a video conference system (or “system”) 100 to enable video and audio communication, in accordance with an example embodiment. As depicted, system 100 includes one or more video endpoint devices 102A-102N, a conference server 140, and a network 160. It is to be understood that the functional division among components of system 100 has been chosen for the purposes of explaining various embodiments and is not to be construed as a limiting example.

Video endpoint devices 102A-102N each include a main camera 104, a secondary camera 106, a display 108, a microphone 110, a speaker 112, at least one processor 114, a network interface (I/F) 116, and a memory 118 that includes software instructions for a foreground mask module 120, a video combiner module 122 and a camera control module 124. At least one of the video endpoint devices, such as video endpoint device 102A, may be a desktop (personal) endpoint device that has at least two video cameras, while the other video endpoint devices need not have two cameras, and could be a laptop computer, a tablet computer, a netbook computer, a desktop computer, a personal digital assistant (PDA), a smart phone, or a room video conferencing endpoint device.

Network interface 116 may include one or more network interface cards that enable the video endpoint device 102A to send and receive data over a network, such as network 160. In general, a user of any video endpoint device of video endpoint devices 102A-102N may record a video or initiate and/or conduct video conference sessions with other participants, such as a user of another video endpoint device, during which the background of the user is optically blurred with respect to the user's face and/or body frame.

Display 108 may include any electronic visual display or screen capable of presenting information in a visual form. For example, display 108 may be an LCD, LED display, an electronic ink display, a touchscreen, and the like. Display 108 may present a graphical user interface that includes interface elements for the display of information related to recording a video and/or initiating a conference session, conducting a conference session, and/or providing an optically blurred background with respect to a foreground object such as the user, during a video recording or a conference session. During a video recording and/or a conference session, still and/or video image data of one or more video recording and/or conference session participants may be presented to a user of any video endpoint device 102A-102N via display 108.

Microphone 110 may include any transducer capable of converting sound to an electrical signal, and speaker 112 may include any transducer capable of converting an electrical signal to sound. Together, microphone 110 and speaker 112 can support video recording and/or bidirectional audio communication between a local user (i.e., a conference session participant local to any of video endpoint devices 102A-102N) and a remote participant (e.g., a user local to another video endpoint device 102A-102N or other device).

Main camera 104 and secondary camera 106 may include any conventional or other image capture device capable of still and/or video data. Both the main camera 104 and the secondary camera 106 may be operated/controlled by one or more software modules of memory 118. The main camera 104 and secondary camera 106 may include hardware elements to enable the adjustment of the camera's settings, including focal length, angle of view, aperture size, and the like. Secondary camera 106 may be a wide-angle camera to include a wide-angle lens to support capturing a still and/or a video of a wide-angle view with respect to the still and/or video captured though the main camera 104. The hardware elements of the secondary camera 106 may be adjusted to optically blur the video data captured from the secondary camera 106. That is, the video data captured from the secondary camera 106 may be intentionally out of focus. The hardware elements of the secondary camera 106 may be adjusted to have a fixed focus.

Foreground mask module 120, video combiner module 122, and camera control module 124 may include one or more modules or units to perform various functions of the embodiments described below. Foreground mask module 120, video combiner module 122 and camera control module 124 may be implemented by any combination of any quantity of software and/or hardware modules or units and may reside within memory 118 of any of video endpoint devices 102A-102N for execution by a processor, such as processor 114.

Processor 114 may be one or more hardware processors configured to execute various tasks, operations, and/or functions for video endpoint devices 102A-102N of system 100 as described herein according to software and/or instructions configured for video endpoint devices 102A-102N. Processor 114 (e.g., a hardware processor) can execute any type of instructions associated with data to achieve the operations detailed herein. Any of the potential processing elements, microprocessors, image processor, digital signal processor, AI-based processor, graphics processors, video encoders/decoders, logic, and/or machines described herein can be construed as being encompassed within the broad term ‘processor’. Processor 114 can transform an element or an article (e.g., data, information) from one state or thing to another state or thing.

Any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory discussed herein may be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

In certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an application specific integrated circuit (ASIC), digital signal processing (DSP) instructions, software [potentially inclusive of object code and source code], etc.) for execution by one or more processor(s), and/or other similar machine, etc. Generally, memory 118 can store data, software, code, instructions (e.g., processor instructions), logic, parameters, combinations thereof, and/or the like used for operations described herein. This includes memory 118 can store data, software, code, instructions (e.g., processor instructions), logic, parameters, combinations thereof, or the like that are executed to carry out operations in accordance with teachings of the present disclosure.

Foreground mask module 120 processes video data captured from the main camera 104 to provide a foreground mask. Initially, foreground mask module 120 extracts a foreground object, also referred to herein as an image of the user in front of the main camera 104, from the video data. Foreground mask module 120 may extract the foreground object from a frame of the video. Foreground mask module 120 may employ conventional or other portrait segmentation techniques to segment a foreground object, for example, a person, an object, or a portion thereof from the background. In some embodiments, foreground mask module 120 extracts a foreground object using conventional or other artificial intelligence techniques. Foreground mask module 120 may use characteristics such as face or feature in order to classify the different parts of an image as being associated with a person in front of the main camera 104. Foreground mask module 120 utilizes the extracted foreground object to generate a foreground mask video including video of the foreground object captured from the main camera 104.

Video combiner module 122 processes the foreground mask video generated in the foreground mask module 120 in combination with optically blurred video data (that is, intentionally out of focus video) captured from secondary camera 106. Video combiner module 122 blends the foreground mask video and the optically blurred video captured from the secondary camera 106 to provide an output video to the video endpoint device 102A-102N, that is a video including the foreground object against a background that is optically blurred. The network interface 116 sends the output video (after the processor 114 has encoded/compressed the output video) over the network to the conference server 140, which sends the video (and audio) to one or more other video endpoint devices participating in a conference session.

Camera control module 124 enables adjustment of camera settings of the main camera 104 and/or the secondary camera 106 using the extracted foreground object data from the foreground mask module 120. In some embodiments, camera control module 124 provides instructions to main camera 104 and/or the secondary camera 106 to cause main camera 104 and/or the secondary camera 106 to change one or more camera settings or options. Camera control module 124 may instruct to control the hardware elements of the main camera 104 and/or the secondary camera 106 to enable a change in camera settings such as focal length (focus distance) or angle of view, corresponding to the foreground object.

Conference server 140 includes a network interface (I/F) 142, at least one processor 144, a memory 146, and a database 148. Conference server 140 may include a rack-mounted server, or any other programmable electronic device capable of executing computer readable program instructions. Network interface 142 enables components of conference server 140 to send and receive data over a network, such as network 160. In general, conference server 140 enables user devices, such as video endpoint devices 102A-102N, to establish and conduct a conference session.

Database 148 may include any non-volatile storage media known in the art. For example, database 148 can be implemented with a tape library, optical library, one or more independent hard disk drives, or multiple hard disk drives in a redundant array of independent disks (RAID). Similarly, data in database 148 may conform to any suitable storage architecture known in the art, such as a file, a relational database, an object-oriented database, and/or one or more tables. Database 148 may store data including data or metadata relating to hosting conference sessions in which optically blurred background is provided in accordance with presented embodiments.

Network 160 may include a local area network (LAN), a wide area network (WAN) such as the Internet, or a combination of the two, and includes wired, wireless, or fiber optic connections. In general, network 160 can be any combination of connections and protocols known in the art that will support communications between video endpoint devices 102A-102N and/or conference server 140 via their respective network interfaces in accordance with the described embodiments.

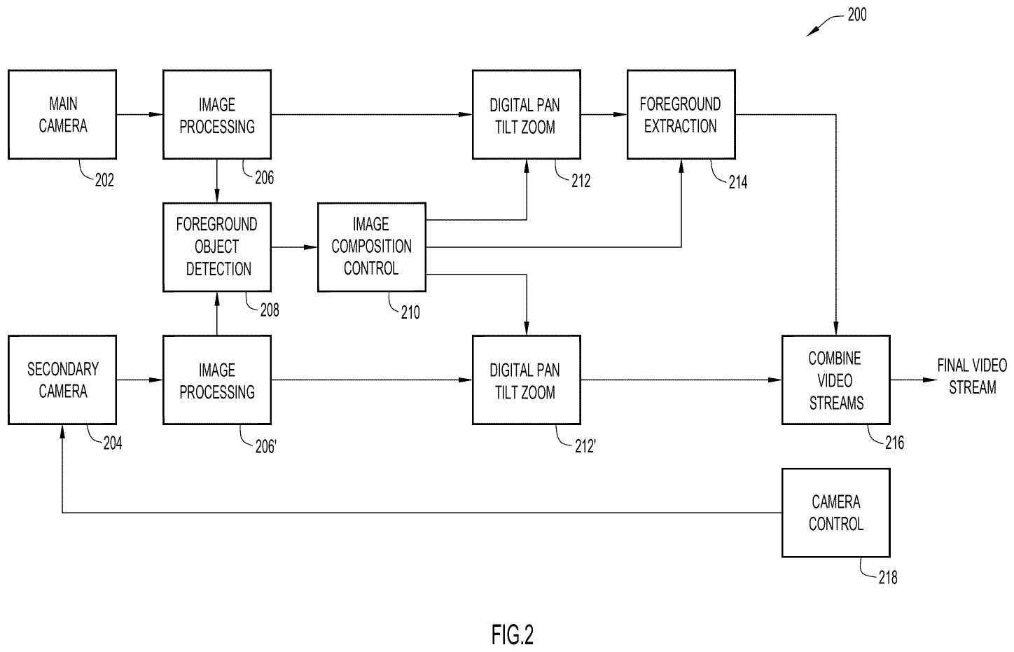

Turning now to FIG. 2, FIG. 2 is a block diagram illustrating an operational flow 200 of a video endpoint device, in accordance with an example embodiment. The operational flow 200 may be an example of execution of the software instructions stored in memory 118 by the processor 114 of video endpoint device 102A of FIG. 1. Processor 114 of FIG. 1 may execute software instructions using foreground mask module 120, video combiner module 122 and camera control module 124 of memory 118 of FIG. 1.

Referring to FIG. 2, the main camera 202 and the secondary camera 204 of a video endpoint device capture video data during video recording and/or an audio and video communication. The hardware elements of the secondary camera 204 may be adjusted to optically blur the video data captured from the secondary camera 204. That is, the video data captured from the secondary camera 204 may be intentionally out of focus.

Image processing operations 206 and 206′ perform image processing on video data received from the main camera 202 and the secondary camera 204, respectively. The image processing operations 206 and 206′ may perform actions including, but not limited to, image acquisition, image restoration, image enhancement, image compression, image segmentation, etc. The image processing operations 206 and 206′ may be performed by o a processor, such as processor 114 of FIG. 1. The image processing operations 206 and 206′ may receive the video data directly from the main camera 202 and/or the secondary camera 204 (after the analog video data has been converted to digital data by the cameras themselves or an intervening analog-to-digital conversion by an interface between the cameras and the processor 114). The image processing operations 206 and 206′ may obtain the digital video data saved in a memory, such as memory 118 of FIG. 1.

In the example embodiment, a foreground object may be initially detected using the video data captured from the main camera 202 and the secondary camera 204. Foreground object detection operation 208 may perform face detection and/or feature detection using the video data from the main camera 202 and the secondary camera 204, after image processing operations 206 and 206′. Foreground object detection operation 208 may employ conventional or other artificial intelligence techniques. Artificial intelligence techniques generally utilize pre-trained labels to detect the face of a person, and/or features including ears, eyes associated with the face of a person. Artificial intelligence techniques may utilize pre-trained characteristics of solid objects to detect any object in front of the camera. Artificial intelligence techniques may rely on machine learning techniques, particularly deep learning and utilize pre-trained models to highlight a foreground object in a video stream. Foreground object detection operation 208 may also determine properties of a foreground object such as margin and/or position coordinates, including center position of the foreground object.

Image composition control operation 210 may use data extracted by foreground object detection operation 208 to provide control instructions to Digital Pan/Tilt/Zoom (DPTZ) operations 212 and 212′. DPTZ operations 212, 212′ may use the control instructions to change camera settings of the main camera 202 and the secondary camera 204, respectively. Foreground object detection operation 208 provides the properties of a foreground object to DPTZ operations 212, 212′ through the image composition control operation 210. DPTZ operations 212, 212′ may aid in controlling a focal length of the main camera 202 and the secondary camera 204, thereby adjusting focus of the main camera 202 and the secondary camera 204 such that the foreground object appears in the same position with respect to the video of the main camera 202 and the secondary camera 204. In particular, DPTZ operation 212 may adjust the camera settings of main camera 202 to focus the main camera 202 on the foreground and generate foreground video data. DPTZ operation 212′ may adjust the camera settings of secondary camera 204 to focus very close to the foreground object or focus beyond infinity so as to be intentionally out of focus on the background, and thus optically blur the background to generate optically blurred background video data.

The main camera 202 and the secondary camera 204 described herein can have different fields of view (FOVs). As described above in connection with FIG. 1, the secondary camera 204 may be a wide angle/view camera having a wide angle lens, resulting in a wider FOV as compared to a FOV of main camera 202. In another embodiment, the main camera 202 may be a wide angle/view camera, resulting in a wider FOV as compared to a FOV of the secondary camera 204. To overcome this, digital zoom may be applied to output of the main camera 202 to have the FOV of the main camera 202 equal or narrow as compared to the FOV of the secondary camera 204.

The FOV of the main camera 202 and the secondary camera 204 may be partially overlapping resulting in the video data captured from the main camera 202 and the secondary camera 204 to be at least partially overlapping. The DPTZ operations 212 and 212′ may adjust a focus distance (focal length) of the main camera 202 and the secondary camera 204, respectively, so as to have the foreground object in a same position with respect to video captured from the main camera 202 and the secondary camera 204. DPTZ operations 212, 212′ may provide digitally adjusted FOVs of the main camera 202 and the secondary camera 204, respectively, such that the foreground object will appear larger in video data obtained from the main camera 202 as compared to the video data obtained from the secondary camera 204.

Foreground extraction operation 214 may generate a foreground mask of video data obtained from main camera 202. Foreground extraction operation 214 receives foreground information from DPTZ operation 212 and image composition control operation 210 with respect to the video data obtained by the main camera 202. The foreground information is further utilized to generate the foreground mask. Foreground extraction operation 214 may generate a position of the foreground mask, and in doing so, may employ conventional or other artificial intelligence techniques to generate the foreground mask. Foreground object detection operation 208 and foreground extraction operation 214 together may be implemented by software instructions in a memory, such as instructions for foreground mask module 120 shown in FIG. 1.

Combine video streams operation 216 may receive foreground mask from foreground extraction operation 214 and background information from DPTZ operation 212′. Combine video streams operation 216 may utilize the video data output by the DPTZ operation 212′ and the foreground mask produced by the foreground extraction operation 214, combine the foreground mask and background video data to generate a blended video stream, i.e., the final output video stream. The final video stream represents a video stream with a true optical blur of the background with respect to the foreground object. Combine video stream operation 216 may be performed by software instructions for the video combiner module 122 shown in FIG. 1.

Depending on the quality and amount of blur of the background in the final video stream obtained from the combine video stream operation 216, camera control operation 218 may further regulate the de-focus adjustment of the secondary camera 204. The camera control operation 218 may generate controls to adjust the hardware elements of the secondary camera 204 (corresponding to the focal length and/or focus distance) to change the amount of optical blur as desired in the video captured by the secondary camera 204. Camera control operation 218 may also generate controls for the hardware elements of the main camera 202 and/or the secondary camera 204 to enable calibration of the focal length to ensure the outlines of the foreground object are closely matching in size and shape in the video data obtained from the main camera 202 and the secondary camera 204. Camera control operation 218 may be implemented by software instructions for the camera control module 124 shown in FIG. 1.

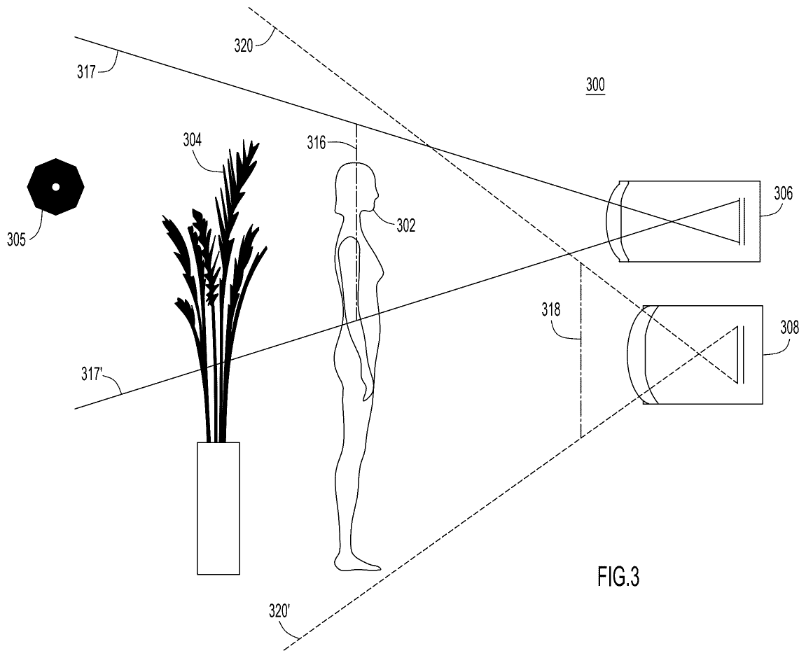

Referring now to FIG. 3, a schematic side view 300 is shown that includes a foreground object 302, a first background object 304, and a second background object 305 captured by a main camera 306 and a secondary camera 308, in accordance with an example embodiment. As described herein, each of the foreground object 302, the first background object 304 and the second background object 305 may be at different distances relative to the position of each of the main camera 306 and the secondary camera 308. In the example herein, the foreground object 302 (a person) may be positioned at a closer distance to the main camera 306 and the secondary camera 308 as compared to the first background object 304 and the second background object 305. The main camera 306 and the secondary camera 308 may be included in a video endpoint device, such as any of the video endpoint devices 102A-102N of FIG. 1. In the example herein, the foreground object 302 is positioned at a closer distance to the video endpoint device (not shown in FIG. 3) as compared to the first background object 304 and the second background object 305.

The main camera 306 may be focused on the foreground object 302 with a plane of focus 316. The background objects 304 and 305 may be at a distance from the foreground object 302 on either side (the first background object 304 is on left side in the example herein) or behind (the second background object 305 is behind the foreground object 302 in the example herein). The main camera 306 may be focused on the foreground object 302 and may also focus on the first background object 304 and the second background object 305. The field of view of the main camera 306 may be the angular sector represented by the lines 317 and 317′.

The secondary camera 308 may be a wide-angle camera with a wider lens as compared to the lens of the main camera 306. A plane of focus 318 of the secondary camera 308 may provide a wider field of view, between lines 320 and 320′ as shown in FIG. 3. The foreground object 302, the first background object 304 and the second background object 305 are included in the field of view of the secondary camera 308 as represented by the lines 320 and 320′. The camera settings of the secondary camera 308 may be set to optically blur the video data captured from the secondary camera, i.e., to provide video data that is intentionally out-of-focus. In an example embodiment, the frame rate of the secondary camera to capture a video may be less than the frame rate of the main camera. In other words, the main camera 306 may capture video data at a faster rate as compared to the secondary camera 308.

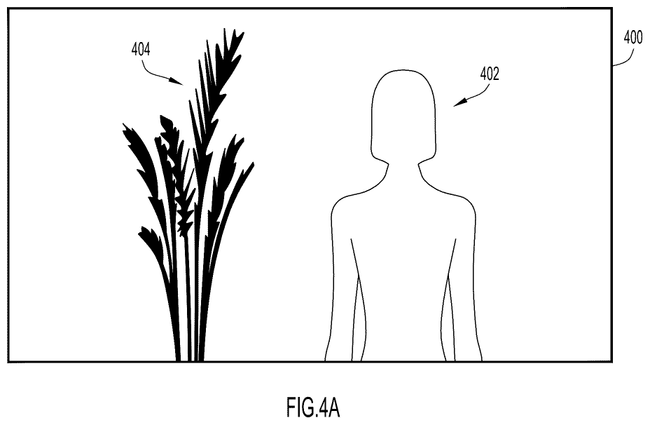

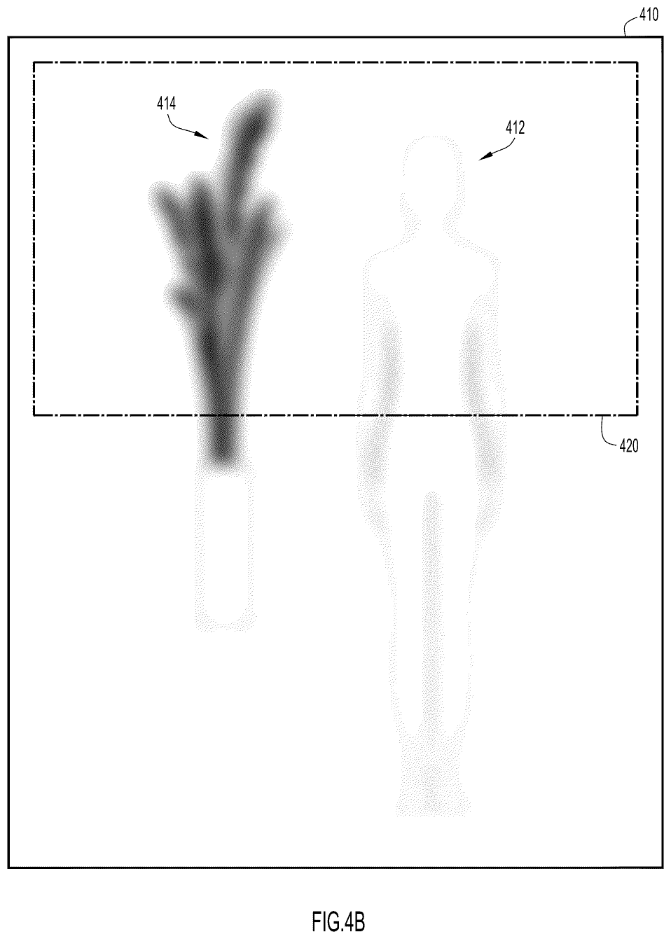

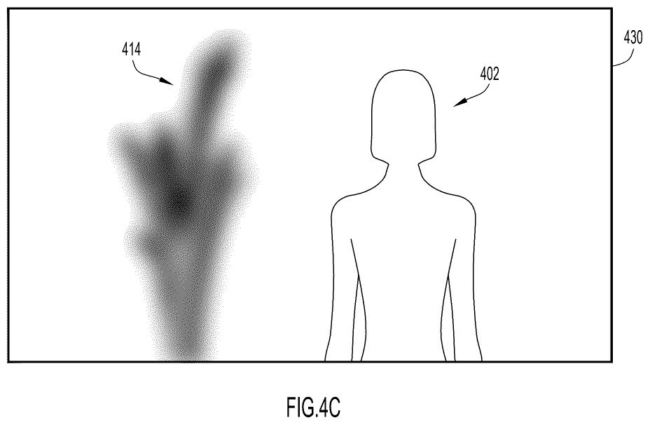

Reference is now made to FIGS. 4A, 4B and 4C for examples of images/frames of video data of a first view captured according to the techniques presented herein. FIG. 4A shows an image or a frame, referred to herein as image 400 of video generated from video captured from the main camera 306. Image 400 from main camera 306 may include an image of the foreground object 402 and an image of the background object 404 illustrating the focus of the main camera 306 on the foreground object 302 and on the background object 304. The second background object 305 as described is behind the foreground object 302 and is not visible in the video (first view) captured by the main camera 306.

FIG. 4B shows an image or a frame, referred to herein as image 410 of video data generated from video of the first view captured from the secondary camera 308. The content of image 410 in FIG. 4B is intentionally blurred to represent an image captured from secondary camera 308 that is set to be intentionally out of focus, according to the techniques presented herein. Image 410 may include an optically blurred image of the foreground object 412 and an optically blurred image of the background object 414 illustrating a wider and larger field of view of the secondary camera 308 on the foreground object 302 and the background object 304. Image section 420 is extracted (cropped) from image 410 obtained from video data of secondary camera 308 to match a size of the image 400 (in FIG. 4A) obtained from video data of main camera 306.

Video streamed from main camera 306 may be blended with video streamed from secondary camera 308 to generate a final video stream (of first view) with a focus on the foreground object 302 against an optically blurred background, i.e., intentionally out-of-focus background object 304. FIG. 4C illustrates a final image 430 generated by combining image 400 (in FIG. 4A) and image section 420 (in FIG. 4B), including the image of foreground object 402 and the optically blurred image of the background object 414. The optically blurred image of the background object 414 in FIG. 4C is intentionally blurred to show that it is a result of intentionally blurred image 410, according to the techniques presented herein.

Main camera 306 and secondary camera 308 are adjusted and calibrated to match the positions and overlap the image of the foreground object 402 and the optically blurred image of the foreground object 412, such that only the image of the foreground object 402 may be visible against an optically blurred image of the background object 414 in the final image 430. The camera settings of the secondary camera 308 can be adjusted/changed in order to change the amount of blur of the optically blurred image of the background object 414 in final image 430.

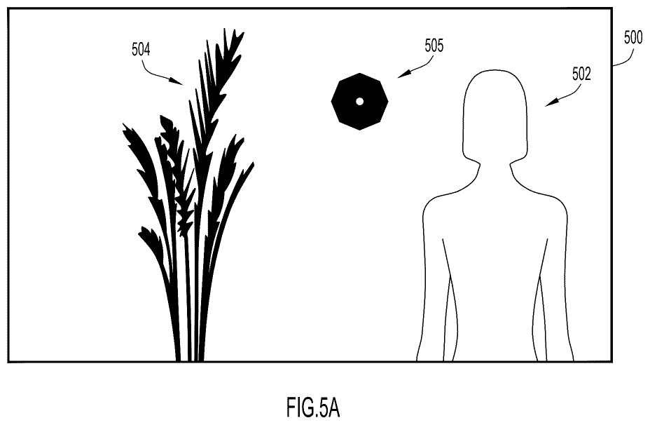

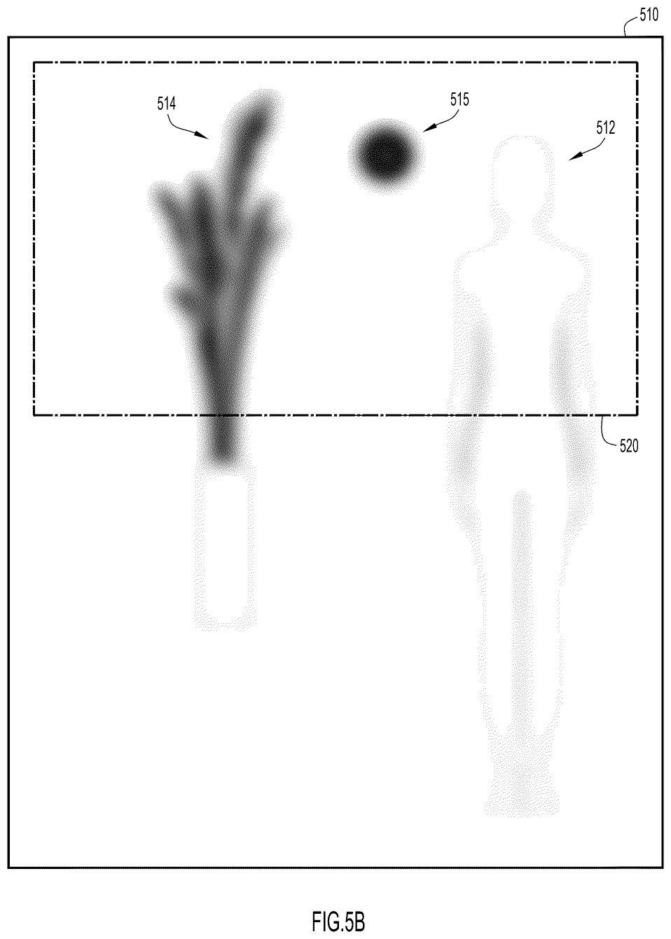

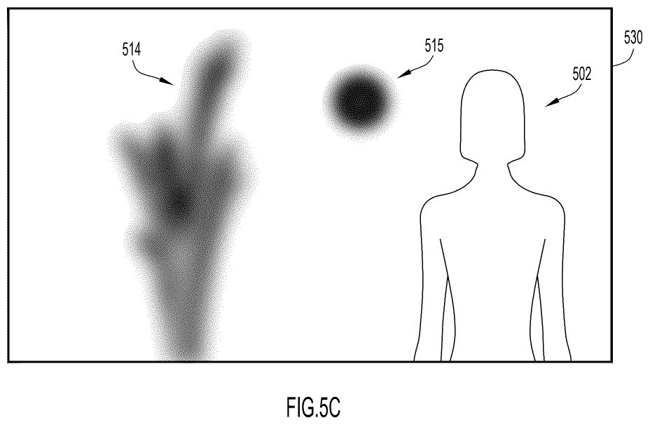

Reference is now made to FIGS. 5A, 5B and 5C for examples of images/frames of video data of a second view captured according to the techniques presented herein. The user, i.e., the foreground object 302 in the example embodiment, may move during a communication session. Over time, as the user moves around, more of the background may be revealed and the background is to be updated to include the background that is visible now and was previously covered/blocked by the user earlier, and/or to cover the area that is covered by the user now and was visible earlier. In other words, the background of the user changes when the user moves, resulting in different views captured by the main camera 306 and the secondary camera 308. In the second view of the example embodiment described herein, the foreground object 302 moves to the right and the second background object 305 (that was behind the foreground object 302 in the first view) becomes visible.

FIG. 5A shows an image or a frame, referred to herein as image 500 of video generated from video of second view captured from the main camera 306. Image 500 from main camera 306 may include an image of the foreground object 502, an image of the first background object 504, and an image of the second background object 505 illustrating the focus of the main camera 306 on the foreground object 302, the first background object 304 and the second background object 305.

FIG. 5B shows an image or a frame, referred to herein as image 510 of video data generated from video of the second view captured from the secondary camera 308. Content of image 510 in FIG. 5B is intentionally blurred to represent optically blurred image content that is captured from secondary camera 308, according to the techniques presented herein. Image 510 may include an optically blurred image of the foreground object 512, an optically blurred image of the first background object 514, and an optically blurred image of the second background object 515 illustrating a wider and larger field of view of the secondary camera 308. Image section 520 is extracted (cropped) from image 510 obtained from video data of secondary camera 308 to match a size of the image 500 (in FIG. 5A) obtained from video data of main camera 306.

Video streamed from main camera 306 may be blended with video streamed from secondary camera 308 to generate an output video stream of the second view with a focus on the foreground object 302 against an optically blurred background, i.e., intentionally out-of-focus first background object 304 and second background object 305. FIG. 5C illustrates a final image 530 generated by combining image 500 (in FIG. 5A) and image section 520 (in FIG. 5B), including the image of foreground object 502, the optically blurred image of the first background object 514 and optically blurred image of the second background object 515. The optically blurred image of the first background object 514 and optically blurred image of the second background object 515 is a result of intentionally blurred image 510. That is, the first background object 514 and the second background object 515 are intentionally blurred in FIG. 5C to indicate that they are optically blurred images of those objects, according to the techniques presented herein.

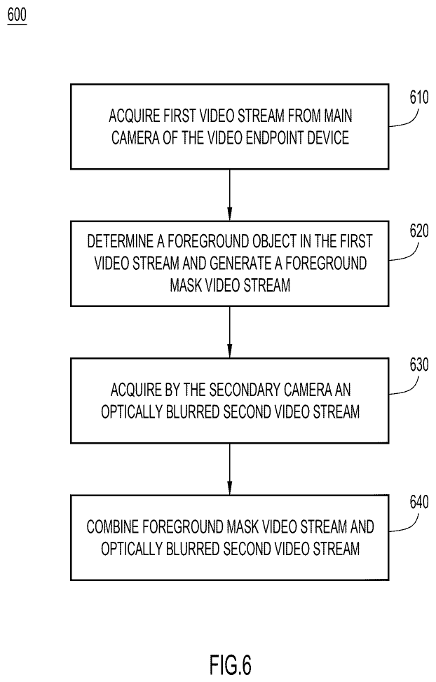

Turning now to FIG. 6, a flow chart depicting a method 600 for optically blurring a background in a video of a video endpoint device is now described, according to an example embodiment.

The video endpoint device may be used for audio and video communication, during which the user may initiate a background blur for the video. On initiation of a background blur by the user, operations of the method 600 are initiated. During the audio and video communication, the main camera and the secondary camera of the video endpoint device may be capturing video and providing a first video stream and a second video stream, respectively.

The first video stream is acquired from the main camera in operation 610. The first video stream may be provided to a processor and/or a memory of the video endpoint device. The processor may perform initial image processing operations and then provide the video stream to the memory.

Operation 620 includes determining a foreground object in the first video stream and generating a foreground mask video stream. Memory of the video endpoint device may employ AI-based processing to detect a margin and/or a position of the foreground object. For example, if a user is in front of the main camera, the first video stream includes the face of the user. AI-based processing may be used to detect features of the face such as eyes and ears. Depending on the positions of such features, a margin around the face and/or the position of the face may be detected. Using this data, a foreground extraction module may employ software instructions to generate a foreground mask from the first video stream. The extracted foreground mask of the first video stream may then be provided as a foreground mask video stream for further processing.

The second video stream is acquired from the secondary camera in operation 630. The secondary camera is intentionally defocused, resulting in an optically blurred video (of a background with respect to the foreground object) in the second video stream. Operation 640 includes combining the optically blurred second video stream acquired in operation 630 and the foreground mask video stream generated in operation 620, to generate an output video stream. The output video stream presents a foreground object, for example the user, against an optically blurred background. As the main camera and the secondary camera continue to capture video of the user, the operations of method 600 may continuously process the video to generate the desired output video stream, even when the user is in motion as illustrated in FIGS. 5A, 5B and 5C.

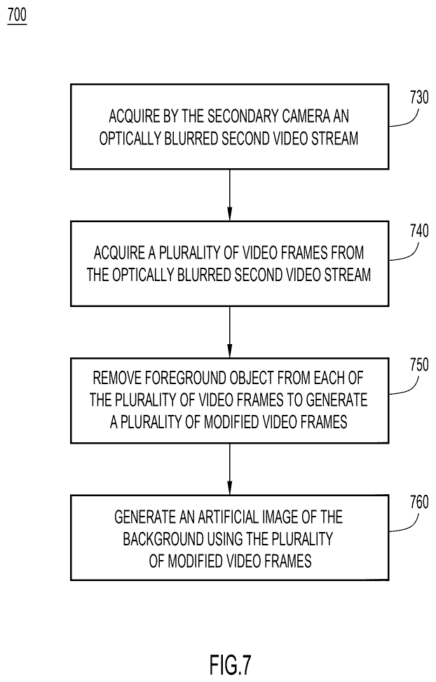

Turning now to FIG. 7, a flow chart depicting method 700 for generating an artificial image of the background from a video captured by a secondary camera of a video endpoint device, according to an example embodiment. Method 700 may involve generating an artificial image from the secondary camera over time. The person in front of the video endpoint device will also be included in the image from the secondary camera, which could create edge artifacts around the foreground object where the images from the primary/main camera and the secondary camera are blended. An artificial image may be used to generate a background image over time where the foreground is removed. Over time, as the person moves around, more of the background will have been revealed and this can be used to generate an image showing the area that is covered by the user right now but was visible earlier. Foreground detection may be executed on the video data captured from the secondary camera, and the data in each video frame may be labelled as either foreground or background. Once the labelling has been done for every video frame over time, all the data labelled as background may be combined into one artificial background image. If the video data obtained and labelled coincides with the user having moved around significantly, the artificial background image generated may contain only background. In an example, the artificial background image may contain a small foreground area which may be used to replace and/or reduce the edge artifacts in the blending process of the video data from the main camera and the secondary camera.

During a communication session using a video endpoint device, a user may initiate a background blur for the video and over time initiate use of a static image as a background of the user. The artificial image may be used in this example as the static image. The artificial image may be used, in an example, as a live image to replace edge artifacts around the foreground object generated during combining the images (video data) from the main camera and the secondary camera. In a live image of the background, the parts that are hidden by the user can be substituted by parts obtained from older images or video frames. The artificial image may be updated with a frame rate of the secondary camera, or at a slower rate if a processor executing generation of the artificial image is resource constrained. In summary, most of the background image may be updated with the frame rate of the secondary camera, but the area around the foreground (edge artifacts) is reused from older frames (artificial image).

The operations of method 700 include generating the artificial image of the background of the user. During the communication session, the main camera and the secondary camera of the video endpoint device may be capturing video and providing a first video stream and a second video stream, respectively.

The second video stream is acquired from the secondary camera in operation 730. The secondary camera is intentionally defocused, resulting in an optically blurred video in the second video stream. Operation 740 includes generating a plurality of video frames or images from the optically blurred video that is intentionally out-of-focus, including continuously updated background data. The background data may be changed in each video frame of the plurality of video frames as result of the user moving, over time. As described previously, over time, as the user moves around, more of the background may be revealed that was previously covered by the user. As illustrated in image section 420 in FIG. 4B and in image section 520 FIG. 5B, the optically blurred image of the second background object 515 is visible in image section 520 due to motion of the user which was not visible in image section 420.

Operation 750 includes removing foreground object(s) from each of the plurality of video frames obtained from operation 740. AI-based image processing may be employed for determining margins and/or position of foreground object, to remove it from each of the plurality of video frames. Operation 750 may provide a plurality of modified video frames, such that each of the modified video frames includes optically blurred images of the background objects (such as background objects 304 and 305 in FIG. 3) without the foreground object (such as the foreground object 302 in FIG. 3).

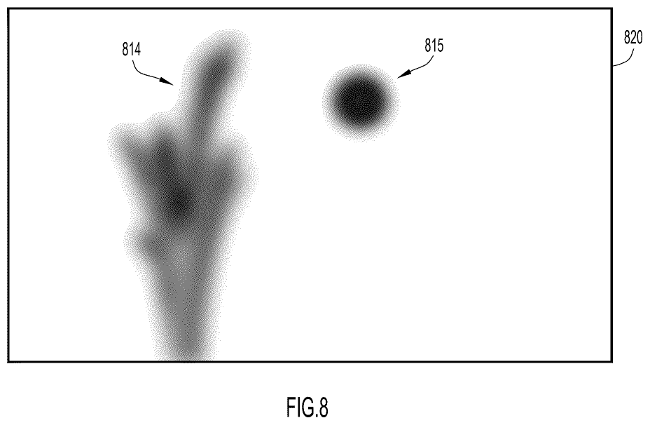

Operation 760 includes generating an artificial image of the background using the optically blurred images of the background captured from the secondary camera (i.e., the plurality of modified video frames). For example, FIG. 8 shows an artificial image 820 that is intentionally blurred image. Image 820 includes blurred images of background objects 814 and 815 (without the image of the foreground object i.e., the user) which is generated by using image section 420 in FIG. 4B and image section 520 in FIG. 5B by employing AI-based image processing to remove the optically blurred image of the foreground object and combining the image sections 420 and 520. Thus, background objects 814 and 815 are intentionally blurred in FIG. 8 according to the techniques presented herein. As the main camera and the secondary camera continue to capture video of the user, the operations of method 700 may continuously process the video to generate an updated artificial image of the background of the user.

In some aspects, the techniques described herein relate to a method including: acquiring a first video stream from a first camera of a video device; detecting a foreground object in the first video stream; generating a foreground mask video stream based on the foreground object detected in the first video stream; acquiring a second video stream from a second camera of the video device, the second camera being adjusted to be intentionally out of focus; and combining the foreground mask video stream and the second video stream to generate an output video stream that includes the foreground object against a background that is optically blurred by the second camera.

In some aspects, the techniques described herein relate to a method, wherein the second camera is a wide-angle camera.

In some aspects, the techniques described herein relate to a method, further including determining, from the first video stream, a position of the foreground object and adjusting a focus of the first camera to the position of the foreground object.

In some aspects, the techniques described herein relate to a method, further including adjusting a focus of the second camera based on a position of the foreground object.

In some aspects, the techniques described herein relate to a method, further including modifying an amount of optical blur in the output video stream by adjusting a focus of the second camera.

In some aspects, the techniques described herein relate to a method, wherein a first field of view of the first camera and a second field of view of the second camera at least partially overlap.

In some aspects, the techniques described herein relate to a method, further including generating, from the second video stream, an artificial background image and replacing one or more edge artifacts around the foreground object in the output video stream using the artificial background image.

In some aspects, the techniques described herein relate to a method, wherein detecting the foreground object is performed using at least one of an artificial intelligence algorithm or an image processing algorithm.

In some aspects, the techniques described herein relate to one or more non-transitory computer readable storage media encoded with instructions that, when executed by a computer processor of a video device, cause the computer processor to perform operations including: acquiring a first video stream from a first camera of the video device; detecting a foreground object in the first video stream; generating a foreground mask video stream based on the foreground object detected in the first video stream; acquiring a second video stream from a second camera of the video device, the second camera being adjusted to be intentionally out of focus; and combining the foreground mask video stream and the second video stream to generate an output video stream that includes the foreground object against a background that is optically blurred by the second camera.

In some aspects, the techniques described herein relate to one or more non-transitory computer readable storage media, wherein the instructions further cause the computer processor to perform determining a position of the foreground object from the first video stream and adjusting a focus of the first camera to the position of the foreground object.

In some aspects, the techniques described herein relate to one or more non-transitory computer readable storage media, wherein the instructions further cause the computer processor to perform adjusting a focus of the second camera based on a position of the foreground object.

In some aspects, the techniques described herein relate to one or more non-transitory computer readable storage media, wherein the instructions further cause the computer processor to perform modifying an amount of optical blur in the output video stream by adjusting a focus of the second camera.

In some aspects, the techniques described herein relate to one or more non-transitory computer readable storage media, wherein the instructions further cause the computer processor to perform generating an artificial background image from the second video stream and replacing one or more edge artifacts around the foreground object in the output video stream using the artificial background image.

In some aspects, the techniques described herein relate to one or more non-transitory computer readable storage media, wherein the instructions further cause the computer processor to perform detecting the foreground object using at least one of an artificial intelligence algorithm or an image processing algorithm.

In some aspects, the techniques described herein relate to an apparatus including, a first camera configured to provide a first video stream; a second camera configured to be intentionally out of focus to provide a second video stream; and a processor configured to execute software instructions to: detect a foreground object in the first video stream; generate a foreground mask video stream based on the foreground object detected in the first video stream; and combine the foreground mask video stream and the second video stream to generate an output video stream that includes the foreground object against a background that is optically blurred by the second camera.

In some aspects, the techniques described herein relate to an apparatus, wherein the second camera is a wide-angle camera.

In some aspects, the techniques described herein relate to an apparatus, wherein the processor is further configured to determine a position of the foreground object from the first video stream and adjust a focus of the first camera and a focus of the second camera using the position of the foreground object.

In some aspects, the techniques described herein relate to an apparatus, wherein the processor is further configured to modify an amount of optical blur in the output video stream by adjusting a focus of the second camera.

In some aspects, the techniques described herein relate to an apparatus, wherein a first field of view of the first camera and a second field of view of the second camera at least partially overlap.

In some aspects, the techniques described herein relate to an apparatus, wherein the processor is further configured to generate an artificial background image from the second video stream and replace one or more edge artifacts around the foreground object in the output video stream using the artificial background image.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source, and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and, in the claims, can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data, or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of,’ one or more of, ‘and/or’ variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

1. A method comprising:
acquiring a first video stream from a first camera of a video device;
detecting a foreground object in the first video stream;
generating a foreground mask video stream based on the foreground object detected in the first video stream;
acquiring a second video stream from a second camera of the video device, the second camera being adjusted to be intentionally out of focus, wherein the second video stream is optically blurred;
determining a plurality of optically blurred background image frames and one or more optically blurred foreground image frames from the second video stream over time;
combining the plurality of optically blurred background image frames to form an artificial background image; and
combining the foreground mask video stream and the artificial background image to generate an output video stream that includes the foreground object against an optically blurred background that comprises the artificial background image.

2. The method of claim 1, wherein the second camera is a wide-angle camera.

3. The method of claim 1, further comprising determining, from the first video stream, a position of the foreground object and adjusting a focus of the first camera to the position of the foreground object.

4. The method of claim 1, further comprising adjusting a focus of the second camera based on a position of the foreground object.

5. The method of claim 1, further comprising modifying an amount of optical blur in the output video stream by adjusting a focus of the second camera.

6. The method of claim 1, wherein a first field of view of the first camera and a second field of view of the second camera at least partially overlap.

7. The method of claim 1, further comprising replacing one or more edge artifacts around the foreground object in the output video stream using the one or more optically blurred foreground image frames.

8. The method of claim 1, wherein detecting the foreground object is performed using at least one of an artificial intelligence algorithm or an image processing algorithm.

9. One or more non-transitory computer readable storage media encoded with instructions that, when executed by a computer processor of a video device, cause the computer processor to perform operations including:
acquiring a first video stream from a first camera of the video device;
detecting a foreground object in the first video stream;
generating a foreground mask video stream based on the foreground object detected in the first video stream;
acquiring a second video stream from a second camera of the video device, the second camera being adjusted to be intentionally out of focus, wherein the second video stream is optically blurred;
determining a plurality of optically blurred background image frames and one or more optically blurred foreground image frames from the second video stream over time;
combining the plurality of optically blurred background image frames to form an artificial background image; and
combining the foreground mask video stream and the artificial background image to generate an output video stream that includes the foreground object against an optically blurred background that comprises the artificial background image.

10. The one or more non-transitory computer readable storage media of claim 9, wherein the instructions further cause the computer processor to perform determining a position of the foreground object from the first video stream and adjusting a focus of the first camera to the position of the foreground object.

11. The one or more non-transitory computer readable storage media of claim 9, wherein the instructions further cause the computer processor to perform adjusting a focus of the second camera based on a position of the foreground object.

12. The one or more non-transitory computer readable storage media of claim 9, wherein the instructions further cause the computer processor to perform modifying an amount of optical blur in the output video stream by adjusting a focus of the second camera.

13. The one or more non-transitory computer readable storage media of claim 9, wherein the instructions further cause the computer processor to perform replacing one or more edge artifacts around the foreground object in the output video stream using one or more optically blurred foreground image frames.

14. The one or more non-transitory computer readable storage media of claim 9, wherein the instructions further cause the computer processor to perform detecting the foreground object using at least one of an artificial intelligence algorithm or an image processing algorithm.

15. An apparatus comprising,
a first camera configured to provide a first video stream;
a second camera configured to be intentionally out of focus to provide a second video stream, wherein the second video stream is optically blurred; and
a processor configured to execute software instructions to:
detect a foreground object in the first video stream;
generate a foreground mask video stream based on the foreground object detected in the first video stream;
determine a plurality of optically blurred background image frames and one or more optically blurred foreground image frames from the second video stream over time;
combine the plurality of optically blurred background image frames to form an artificial background image; and
combine the foreground mask video stream and the artificial background image to generate an output video stream that includes the foreground object against an optically blurred background that comprises the artificial background image.

16. The apparatus of claim 15, wherein the second camera is a wide-angle camera.

17. The apparatus of claim 15, wherein the processor is further configured to determine a position of the foreground object from the first video stream and adjust a focus of the first camera and a focus of the second camera using the position of the foreground object.

18. The apparatus of claim 15, wherein the processor is further configured to modify an amount of optical blur in the output video stream by adjusting a focus of the second camera.

19. The apparatus of claim 15, wherein a first field of view of the first camera and a second field of view of the second camera at least partially overlap.

20. The apparatus of claim 15, wherein the processor is further configured to replace one or more edge artifacts around the foreground object in the output video stream using the one or more optically blurred foreground image frames.
